(19) United States
(12) Patent Application Publication
(10) Pub. No.: US 2008/0181314 A1
(43) Pub. Date: Jul. 31, 2008

(54) IMAGE CODING APPARATUS AND IMAGE CODING METHOD

(76) Inventors: Kenjiro TSUDA, Osaka (JP); Hiroshi ARAKAWA, Nara (JP)

Correspondence Address: WENDEROTH, LIND & PONACK L.L.P., 2033 K. STREET, NW, SUITE 800, WASHINGTON, DC, 20006, US

(21) Appl. No.: 12/022,227

(22) Filed: Jan. 30, 2008

(30) Foreign Application Priority Data
Jan. 31, 2007 (JP) 2007-022051

(51) Int. Cl. H04N 7/24

(52) U.S. Cl. 375/240.28; 375/E07.003

(57) ABSTRACT

The object is to provide an image coding apparatus capable of converting a frame rate without causing an increase of computation and coding amounts. An image coding apparatus 100 includes a frame managing unit 102 which outputs, for inputted image data, frame data and a pseudo-frame generation control signal for generating a pseudo frame, at a predetermined timing at which a frame rate of the inputted image data is changed, the pseudo frame having same image data as one of the frame data; a pseudo frame generating unit 105 which generates skip information indicating the pseudo frame, based on the pseudo-frame generation control signal, so as to output the generated skip information; a coding unit 103 which codes the frame data so as to output coded data; and a stream generating unit 104 which combines the coded data and the skip information in a predetermined order so as to output the combined data to a reproducing apparatus 110-side as stream data.

### BACKGROUND OF THE INVENTION

(1) Field of the Invention

The present invention relates to an image coding apparatus and an image coding method for achieving inexpensive coding of moving picture data using the H.264 standard in the BD-ROM standard and the AVC-HD standard with reduced computation amounts and circuit size.

(2) Description of the Related Art

Generally, for coding of moving pictures, a method of reducing the frame rate of current data to be coded is used in order to enhance coding efficiency and prevent generated coding amounts from increasing. Further, with camera capturing apparatuses, it is also possible to capture moving picture data at a low frame rate in advance, and transmit the captured data to coding apparatuses.

However, there are cases where streams coded at a reduced frame rate cannot be reproduced since the streams do not meet the standard of the reproducing apparatus. For example, in the BD-ROM standard (BD-J Baseline Application and Logical Model Definition for BD-ROM—March 2005) and the AVC-HD standard which has been standardized as a subset of the BD-ROM standard for video cameras, when data is recorded at the horizontal resolution of 1280 pixels and the vertical resolution of 720 pixels, for example, streams of 30 frames per second are not specified, although streams of 60 frames per second are specified in the specification. For this reason, the streams coded at the frame rate of 30 frames per second by conventional coding apparatuses cannot be reproduced by reproducing apparatuses compliant with the BD-ROM standard and/or the AVC-HD standard. Japanese Unexamined Patent Application Publication 2002-514866 (hereinafter referred to as Patent Reference 1) discloses an example of conventional image coding apparatuses.

FIGS. 1A, 1B, and 1C are block diagrams illustrating examples of conventional image coding apparatuses. FIGS. 1A, 1B, and 1C each illustrate a different case.

FIG. 1A illustrates a case where a 30p input is coded at a frame rate of 30p. In the figure, an image coding apparatus 700 includes an input processing unit 701, a frame managing unit 702, a coding unit 703, and a stream generating unit 704. Into the input processing unit 701, 30p input image data with the horizontal resolution of 1280 pixels and the vertical resolution of 720 pixels is inputted, for example. Then, the frame managing unit 702 determines a frame to be coded based on a coding structure of Group of Pictures (GOP), for example, and outputs frame data to the coding unit 703 at a predetermined timing. The coding unit 703 performs processing such as motion vector detection, motion compensation, orthogonal transformation, quantization, and entropy coding, and outputs coding information to the stream generating unit 704. The stream generating unit 704 adds header information and the like to the coding information, and outputs the resulting information as stream data.

FIG. 1B illustrates a case where a 30p input is coded at a frame rate of 30p and reproduced at a frame rate of 60p, which corresponds to Patent Reference 1. The image coding apparatus 700 has the same functional structure as the functional structure illustrated in FIG. 1A, and performs the same processing. A standard-compliant reproducing apparatus 801 includes a decoding unit 811, a frame rate converting unit 812, and a displaying unit 813, and is capable of converting a moving picture decoded by the decoding unit 811 at the frame rate of 30p into a moving picture of a frame rate of 60p and displaying the resulting moving picture in the displaying unit 813 at a high frame rate.

FIG. 1C illustrates a case where a 60p input is coded at a frame rate of 60p. In the figure, an image coding apparatus 900 includes an input processing unit 901, a frame managing unit 902, a coding unit 903, and a stream generating unit 904. The image coding apparatus 900, an example of conventional image coding apparatuses, is the image coding apparatus 700 of FIG. 1A with an additional capability of coding at 60p. Accordingly, when 60p input image data with the horizontal resolution of 1280 pixels and the vertical resolution of 720 pixels is inputted to the input processing unit 901, for example, processing similar to that in FIG. 1A is performed, and the stream generating unit 904 generates 60p stream data. Since the stream data is specified in the BD-ROM standard and the AVC-HD standard, it can be reproduced by a standard-compliant reproducing apparatus 800.

Furthermore, there exists a technology that a video coder judges a model of calculation amounts of a decoder using either information transmitted from the decoder or information from previous knowledge, and dynamically adjusts coding accordingly (see, for example, Japanese Unexamined Patent Application Publication 2005-260935, hereinafter referred to as Patent Reference 2).

However, when trying to provide an image coding apparatus inexpensively, there is a problem that computation amounts and circuit size increase when coding is performed at a high frame rate compliant with standards. Furthermore, in the case where a target bit rate is already determined, there is a problem that image quality deteriorates because it is not possible to increase coding amounts. Moreover, in the case where coding is performed at a low frame rate by reducing computation amounts, there is a problem that the frame rate is not compliant with the standards.

More specifically, in the case of the image coding apparatus 700 illustrated in FIG. 1A, which is an example of conventional image coding apparatuses, 30p stream data is generated since 30p input image data is coded. With the frame rate of this stream data, there is a problem that the standard-compliant reproducing apparatus 800 cannot reproduce the stream data, because the frame rate of this stream data is not specified in the BD-ROM standard and the AVC-HD standard. In addition, since the BD-ROM standard and the AVC-HD standard, the standards that the standard-compliant reproducing apparatus 801 illustrated in FIG. 1B is compliant with, are not compliant with a frame rate of 30p, there is a problem that the stream data cannot be decoded by the decoding unit 811 and be reproduced by the standard-compliant reproducing apparatus 801, as in the case of FIG. 1A. Furthermore, there is also a problem that the computation amounts of the image coding apparatus 900 illustrated in FIG. 1C are larger than that of the image coding apparatus 700.

In addition, a mere increase in a frame rate by simply skipping frames does not enable smooth reproduction. Moreover, even judging of a model of calculation amounts of a decoder as disclosed in Patent Reference 2 cannot guarantee compatibility with the BD standard and the AVC-HD standard.

The present invention has been conceived in view of the above described problems, and an object thereof is to provide an image coding apparatus capable of performing image coding in which a frame rate of input image data can be converted without deterioration in coding efficiency.

### SUMMARY OF THE INVENTION

In order to solve the above described problems, the image coding apparatus according to the present invention is an image coding apparatus including: a frame managing unit which outputs, for inputted image data, frame data and a pseudo-frame generation control signal for generating a pseudo frame, at a predetermined timing at which a frame rate of the inputted image data is changed, the pseudo frame having same image data as one of the frame data; a pseudo frame generating unit which generates skip information indicating the pseudo frame, based on the pseudo-frame generation control signal outputted from the frame managing unit, so as to output the generated skip information; a coding unit which codes the frame data so as to output coded data; and a stream generating unit which combines, in a predetermined order, the coded data outputted from the coding unit and the skip information generated by the pseudo frame generating unit, so as to output the combined data as stream data.

With this structure, the pseudo frame generating unit is capable of generating skip information for generating a pseudo frame having the same image data as one of the frame data, and the stream generating unit combines the coded data and the skip information, and therefore the image coding apparatus becomes capable of generating stream data for which the frame rate of the input image data is converted without decreasing the coding efficiency.

Furthermore, the pseudo frame generating unit of the image coding apparatus according to the present invention generates, as the skip information, skip information indicating that a pseudo frame having same image data as preceding frame data is generated, and the stream generating unit generates stream data having a frame rate that is double the frame rate by combining the coded data and the skip information alternately.

With this structure, since the pseudo frame generating unit generates a pseudo frame using the skip information generated by the pseudo frame generating unit, it is possible to generate the pseudo frame having the same data as the preceding frame data, without adding the image data to the stream data, and to generate, by the stream generating unit, stream data having a doubled frame rate.

Note that the present invention can be implemented not only as an image coding apparatus as described, but also as: an image coding method having, as steps, the characteristic units included in the image coding apparatus; a program which causes a computer to execute such steps; and an integrated circuit. Furthermore, it is needless to say that such a program can be distributed via a recoding medium such as CD-ROMs, and via a transmitting medium such as the Internet.

According to the image coding apparatus and the image coding method according to the present invention, with the frame rate of a current moving picture to be coded data being 30 frames per second, it is possible to convert streams, generated after coding, into streams of 60 frames per second, for example, by generating a pseudo frame using a macroblock skip specified in a coding method. Therefore, the image coding apparatus makes it possible to generate a coded stream compatible to be reproduced by a reproducing apparatus which is compliant with a frame rate specified in the BD-ROM standard, the AVC-HD standard and the like, by converting a frame rate of input image data, without increasing coding computation amounts and coding amounts.

Further Information About Technical Background to this Application

The disclosure of Japanese Patent Application No. 2007-022051 filed on Jan. 31, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1A is a block diagram of an image coding apparatus as an example of conventional image coding apparatuses in the case where a 30p input is coded at a frame rate of 30p;

FIG. 1B is a block diagram of an image coding apparatus as an example of conventional image coding apparatuses in the case where a 30p input is coded at a frame rate of 30p, and reproduced at a frame rate of 60p;

FIG. 1C is a block diagram of an image coding apparatus as an example of conventional image coding apparatuses in the case where a 60p input is coded at a frame rate of 60p;

FIG. 2 is a block diagram of an image coding apparatus according to the present invention;

FIG. 3 is a flowchart illustrating operational procedures of an image coding apparatus according to the present invention;

FIG. 4 is an illustration diagram illustrating inserting of pseudo frames and determination of a coding structure;

FIG. 5 is an illustration diagram illustrating division of a frame into macroblocks;

FIG. 6A is schematic illustration diagram of a stream generated by a stream generating unit in the case of CABAC;

FIG. 6B is schematic illustration diagram of a stream generated by a stream generating unit in the case of CAVLC;

FIG. 7A is a reference diagram of stream data in the case where the structure of Group of Pictures (GOP) is an IPP structure and coding is performed using CABAC; and

FIG. 7B is a reference diagram of stream data in the case where pseudo frames are generated in bidirectional prediction.

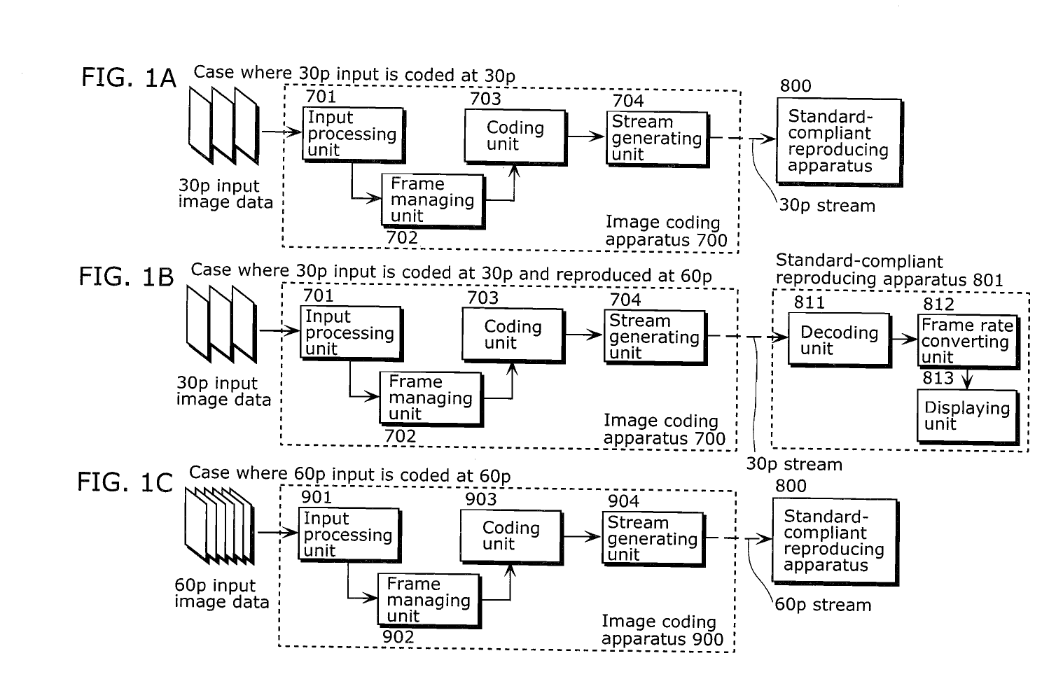

### DESCRIPTION OF THE PREFERRED EMBODIMENTS

With reference to the accompanying drawings, an embodiment of the present invention is described below.

### First Embodiment

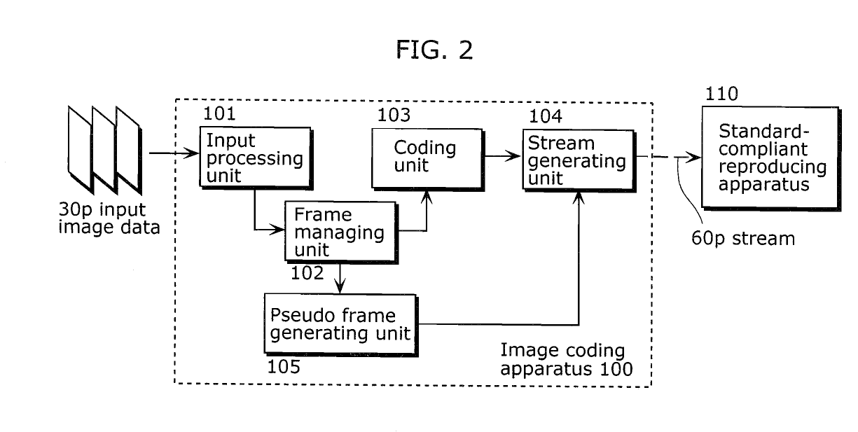

FIG. 2 is a block diagram illustrating an embodiment of the present invention. In the figure, an image coding apparatus 100 includes an input processing unit 101, a frame managing unit 102, a coding unit 103, a stream generating unit 104, and a pseudo frame generating unit 105.

Into the input processing unit 101, 30p input image data with the horizontal resolution of 1280 pixels and the vertical resolution of 720 pixels is inputted, for example. Then, with an assumption that pseudo frames are inserted into a data sequence, the frame managing unit 102 determines a coding structure of a GOP, for example, and outputs frame data to the coding unit 103 and a pseudo-frame generation control signal to the pseudo frame generating unit 105 at a predetermined timing.

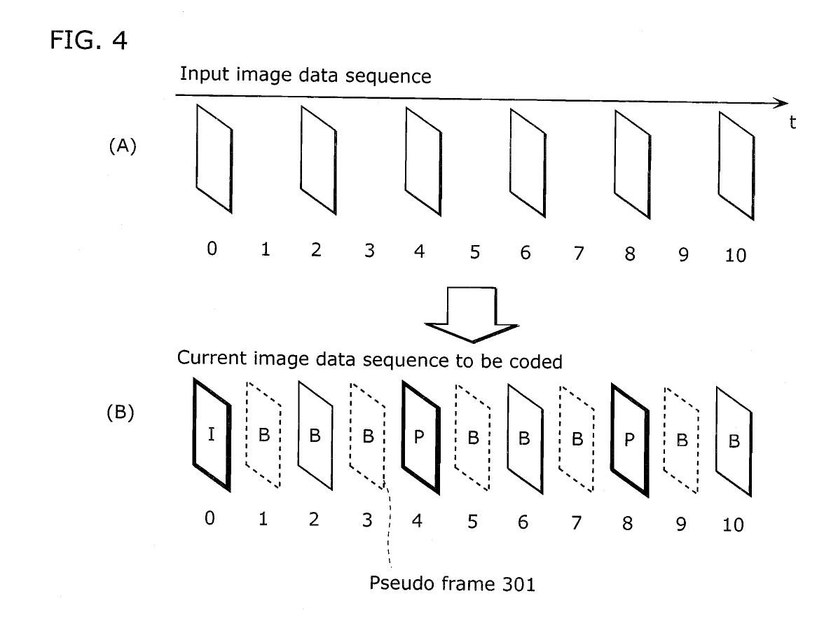

FIG. 4 is an illustration diagram illustrating inserting of pseudo frames and determination of a coding structure. FIG. 4(A) illustrates an image data sequence which has been inputted, and FIG. 4(B) illustrates a data sequence into which pseudo frames have been inserted and a coding structure of which has been determined.

The frames illustrated in FIG. 4(B) with dotted lines are pseudo frames 301. In FIG. 4, the pseudo frames 301 are inserted in between frames of the image data sequence which has been inputted at 30 frames per second, for example, so that with an assumption that the image data sequence is now an image data sequence with a doubled frame rate, that is, 60 frames per second, a GOP structure is determined with the pseudo frames 301 inserted. The even-numbered frames in the figure are outputted to the coding unit 103. For the odd-numbered pseudo frames 301, a pseudo-frame generation control signal is outputted to the pseudo frame generating unit 105.

The coding unit 103 is compliant with the H.264 standard, for example, and performs processing such as motion vector detection, motion compensation, orthogonal transformation, quantization, and entropy coding, and outputs coded data to the stream generating unit 104.

The pseudo frame generating unit 105 generates pseudo frame data based on the pseudo-frame generation control signal outputted from the frame managing unit 102, and outputs the generated pseudo frame data to the stream generating unit 104. In the case where the H.264 standard is utilized for image coding, it is possible to provide pseudo frames by skip-coding all macroblocks within a frame when coding the macroblocks each of which is a coding unit.

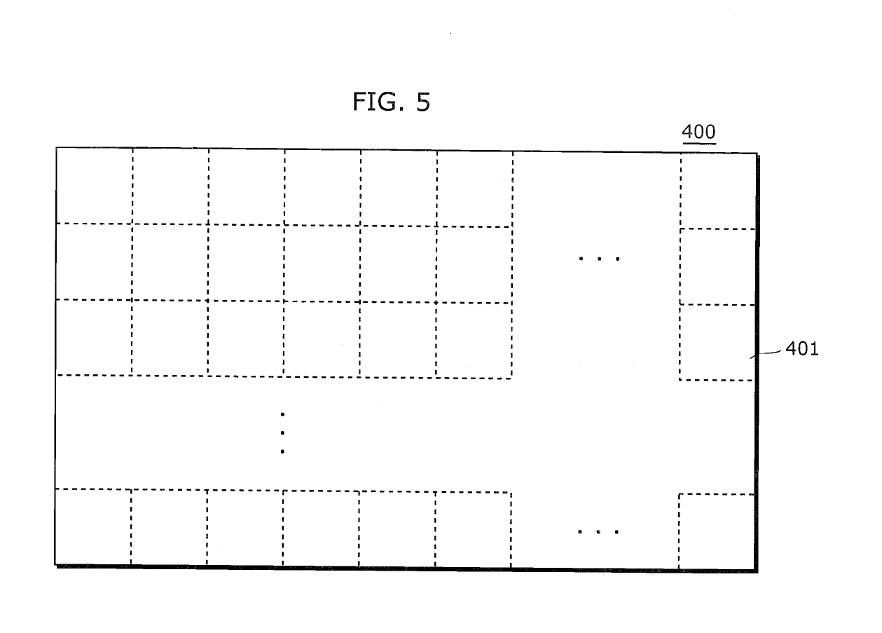

FIG. 5 is an illustration diagram illustrating division of a frame 400 into macroblocks. Small blocks illustrated with dotted lines in the figure represent macroblocks 401. Note that in some cases, frames are called pictures, and pictures are further divided into units called slices so as to perform coding on a slice-by-slice basis.

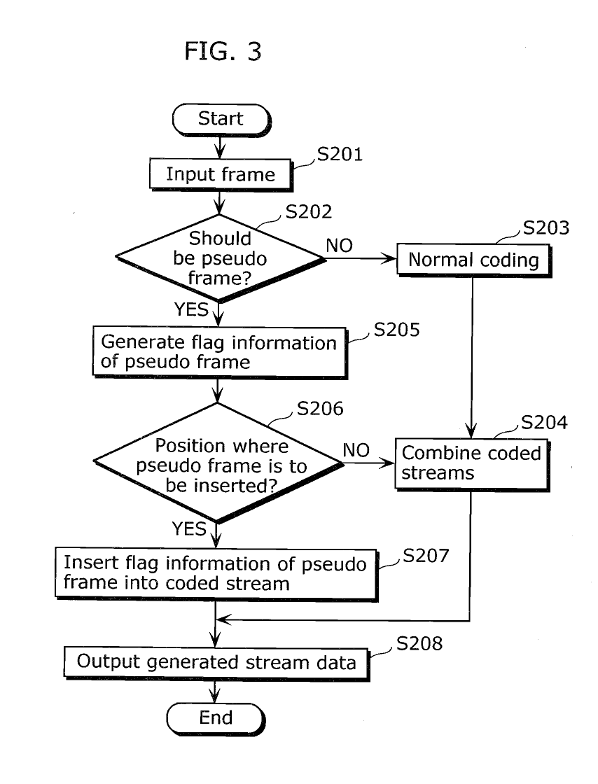

FIG. 3 is a flowchart illustrating operational procedures of the image coding apparatus 100 according to the present invention.

At first, frame data is inputted into the input processing unit 101 as input image data (S201), and the frame managing unit 102 judges whether or not there should be pseudo frames in order to change the frame rate (S202).

Then, in the case where the frame data is ordinary frame data on a frame located at an odd-numbered position where there should not be a pseudo frame (No in S202), the coding unit 103 performs ordinary coding (S203). Further, coded streams which have been coded by the coding unit 103 are combined (S204).

Next, in the case where the frame data is on a frame located at an even-numbered position where there should be a pseudo frame (Yes in S202), the pseudo frame generating unit 105 generates flag information of a pseudo frame (S205), and then, the stream generating unit 104 judges, based on the pseudo-frame generation control signal outputted from the frame managing unit 102, whether or not the position is where a pseudo frame stream is to be inserted (S206).

Then, in the case where it is judged that the position is where the pseudo frame is to be inserted (Yes in S206), the stream generating unit 104 identifies a combination position where skip information is inserted and combines the flag information of the pseudo frame with the coded stream (S207), and outputs the generated stream to a standard-compliant reproducing apparatus 110 (S208).

On the other hand, in the case where it is not judged that the position is where the pseudo frame is to be inserted (No in S206), the stream generating unit 104 combines the coded streams (S204), outputs the generated stream data to the standard-compliant reproducing apparatus 110 (S208), and completes the series of processing.

Next, a specific example of stream data generated by the stream generating unit 104 of the image coding apparatus 100 shall be described below.

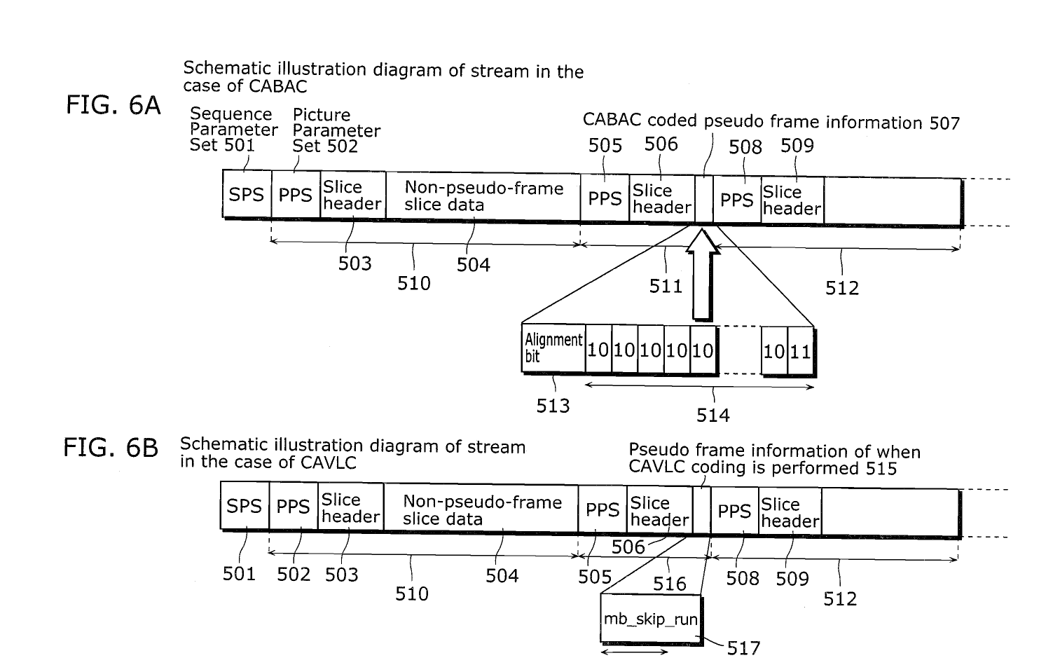

FIG. 6A is a schematic illustration diagram of a stream generated by the stream generating unit 104 in the case of Context-Adaptive Binary Arithmetic Coding (CABAC). FIG. 6B is a schematic illustration diagram of a stream generated by the stream generating unit 104 in the case of Context-Adaptive Variable-Length Coding (CAVLC).

The stream compliant with the H.264 standard, illustrated in FIG. 6A, includes a sequence parameter set (SPS) 501, a picture parameter set (PPS) 502, a slice header 503, and non-pseudo-frame slice data 504. The non-pseudo-frame slice data 504 includes coding information of macroblocks corresponding to the number of macroblocks per picture or slice. One picture is usually made up of one slice, although there are cases where one picture is made up of more than one slice. The PPS 502 includes information indicating which picture is to be referred to, and in the case where a pseudo frame is to be coded using CABAC coded pseudo frame information 507 which has been coded in CABAC, it is specified at the PPS 505a that a preceding frame is to be referred to. For a frame subsequent to the pseudo frame, the PPS 508 may refer to the pseudo frame as a preceding frame, or to a preceding frame to which the pseudo frame refers.

With the H.264 standard, it is possible to code macroblocks almost without generating computation and coding amounts, by classifying all macroblocks included in a frame into a type called “skip” and coding only flags. In the H.264 standard, coding is performed only on flag information immediately before an initial macroblock and coding on all the macroblocks included in the frame is skipped, using “mb_skip_flag” and “end_of_slice_flag” when CABAC is utilized, and “mb_skip_run” when CAVLC is utilized as entropy coding. Especially in the case where CABAC coding is performed, a result of arithmetic coding in CABAC on a bit sequence including flag information is used as final pseudo frame information.

To be more specific, in the case of CABAC in FIG. 6A, a portion (514) is inserted into a stream 511 as CABAC coded pseudo frame information 507 and arithmetic coding is performed in CABAC, where aligning in the portion 514 are: 0 to 7 “1” for performing byte alignment of the header portion with “cabac alignment one bit (513)”; “10” that is information representing a pseudo frame including “mb_skip_flag” and “end_of_slice_flag” (one macroblock per picture); and one “11” that lastly indicates the end. In FIG. 6B, the number of macroblocks per picture is set with “mb_skip_run (517)” in pseudo frame information of when CAVLC coding is performed 515, and “mb_skip_run (517)” is inserted into a stream 516.

In the present embodiment, “mb_skip_flag”, “end_of_slice_flag” and “mb_skip_run” are used in order to minimize the computation amounts and coding amounts. Note, however, that all the macroblocks may be coded without the processing such as motion vector detection, orthogonal transformation, and quantization, as macroblocks having no quantized orthogonal transformation coefficient information and no motion vector information and motion vector difference information which are limited only to forward reference. Further, it may be designed in such a manner that pseudo frame information is created in advance on a frame basis, stored in a buffer memory, and read out by the pseudo frame generating unit 105 from the buffer memory at a necessary timing. Note that frames recited in the present embodiment correspond to pictures in the H.264 standard.

Furthermore, in the case of the MPEG2 standard, all macroblocks may be coded without the processing such as motion vector detection, orthogonal transformation, and quantization, as macroblocks having no motion vector information, motion vector difference information, and quantized orthogonal transformation coefficient information. In addition, coding of macroblocks can be skipped using a macroblock address after only the initial macroblock is coded as a macroblock having no information.

In addition, by generating frames in which preceding and subsequent frames of the pseudo frames are combined, it is possible to generate pseudo frames with smooth motions. The frames in which the preceding and subsequent frames of the pseudo frames are combined are generated by coding all the macroblocks of pseudo frames as skip macroblocks of bidirectional prediction, or by coding all the macroblocks as macroblocks having no motion vector information, motion vector difference information, and quantized orthogonal transformation coefficient information and further coding as bidirectional prediction blocks.

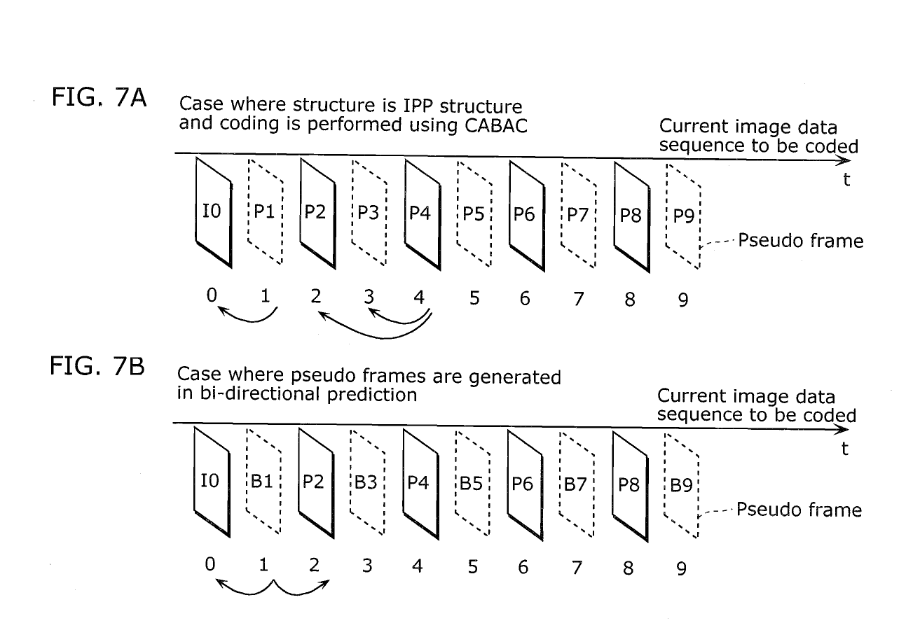

To be more specific, FIG. 7A is a reference diagram of stream data in the case where the structure of Group of Pictures (GOP) takes an IPP structure and coding is performed using CABAC. In the figure, a picture P1 which serves as a pseudo frame refers to a picture 10, and a picture P4 which is ordinary frame data may refer to either a picture 3 which serves as a pseudo frame or a picture P2 which is an ordinary frame. FIG. 7B illustrates a case where pseudo frames are generated in bidirectional prediction. A pseudo frame B1 in the figure can be generated by referring to a picture 10 and a picture P2 in the bidirectional reference and calculating an average value of the pixel values of the picture 10 and the picture P2 after combining them.

The stream generating unit 104 combines coded data and pseudo data in a predetermined order, adds header information, and outputs the resulting data as stream data. In the H.264 standard, in the case where CABAC is used as entropy coding, pseudo frame data are combined after performing CABAC processing. In the ordinary coding, the coding rate of stream data is controlled using a predetermined algorithm in order to match a target coding rate. Note, however, that in the present embodiment, it is desirable to control the coding rate by calculating a target coding rate on every two frames, taking pseudo frames into account.

The stream data generated in the described manner is 60p data since pseudo frame data is added, and therefore, the stream data can be reproduced by the standard-compliant reproducing apparatus 110 which is compliant with the BD-ROM standard and the AVC-HD standard.

In the present embodiment, the description has been provided of the case where the horizontal resolution is 1280 pixels, the vertical resolution is 720 pixels, the input frame rate is 30p, and the output frame rate is 60p. Note, however, that the present invention can be applied to any cases as long as the number of horizontal pixels, the number of vertical pixels, and the output frame rate are within a range compliant with the standard, and the input frame rate is lower than the output frame rate. Furthermore, the present invention can also be applied to cases of progressive scanning and of interlaced scanning.

As described above, the image coding apparatus according to the present invention enables reproduction performed by reproducing apparatuses compliant with the BD-ROM standard, the AVC-HD standard and the like without increasing coding computation amounts and coding amounts. This is made possible since, while the frame rate of moving picture data to be coded is 30 frames per second, the frame rate of the stream generated after coding is performed becomes 60 frames per second as a result of generating pseudo frames utilizing macroblock skip specified in the coding method.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The image coding apparatus and the image coding method according to the present invention are useful for achieving cost optimization when recording video by coding moving pictures with use of digital video cameras and the like.

1. An image coding apparatus comprising:
a frame managing unit operable to output, for inputted image data, frame data and a pseudo-frame generation control signal for generating a pseudo frame, at a predetermined timing at which a frame rate of the inputted image data is changed, the pseudo frame having same image data as one of the frame data;
a pseudo frame generating unit operable to generate skip information indicating the pseudo frame, based on the pseudo-frame generation control signal outputted from said frame managing unit, so as to output the generated skip information;
a coding unit operable to code the frame data so as to output coded data; and
a stream generating unit operable to combine, in a predetermined order, the coded data outputted from said coding unit and the skip information generated by said pseudo frame generating unit, so as to output the combined data as stream data.

2. The image coding apparatus according to claim 1,
wherein in a case where a coding method used by said coding unit is the H.264 standard and CABAC is used as entropy coding, the skip information generated by said pseudo frame generating unit uses mb_skip_flag and end_of_slice_flag.

3. The image coding apparatus according to claim 1,
wherein in a case where a coding method used by said coding unit is the H.264 standard and CAVLC is used as entropy coding, the skip information generated by said pseudo frame generating unit uses mb_skip_run.

4. The image coding apparatus according to claim 1,
wherein said pseudo frame generating unit is operable to generate, as the skip information, skip information indicating that a pseudo frame having same image data as preceding frame data is generated, and
said stream generating unit is operable to generate stream data having a frame rate that is double the frame rate by combining the coded data and the skip information alternately.

5. The image coding apparatus according to claim 1,
wherein said pseudo frame generating unit is operable to generate skip information indicating that a pseudo frame having pixel data which is an average value of pixel data of preceding and subsequent frame data is generated, and
said stream generating unit is operable to generate stream data having a frame rate that is double the frame rate by combining the coded data and the skip information alternately.

6. The image coding apparatus according to claim 1,
wherein said frame managing unit is operable to control a coding rate by calculating a target coding rate every two frames as the predetermined timing at which the frame rate is changed.

7. An image coding method comprising:
outputting, for inputted image data, frame data and a pseudo-frame generation control signal for generating a pseudo frame, at a predetermined timing at which a frame rate of the inputted image data is changed, the pseudo frame having same image data as one of the frame data;
generating skip information indicating the pseudo frame, based on the pseudo-frame generation control signal outputted in said outputting, so as to output the generated skip information;
coding the frame data so as to output coded data; and
combining, in a predetermined order, the coded data outputted in said coding and the skip information generated in said generating, so as to output the combined data as stream data.

8. A computer program product for image coding which, when loaded into a computer, allows the computer to execute:
outputting, for inputted image data, frame data and a pseudo-frame generation control signal for generating a pseudo frame, at a predetermined timing at which a frame rate of the inputted image data is changed, the pseudo frame having same image data as one of the frame data;
generating skip information indicating the pseudo frame, based on the pseudo-frame generation control signal outputted in said outputting, so as to output the generated skip information;
coding the frame data so as to output coded data; and
combining, in a predetermined order, the coded data outputted in said coding and the skip information generated in said generating, so as to output the combined data as stream data.

9. An image coding circuit comprising:
a frame managing circuit which outputs, for inputted image data, frame data and a pseudo-frame generation control signal for generating a pseudo frame, at a predetermined timing at which a frame rate of the inputted image data is changed, the pseudo frame having same image data as one of the frame data;
a pseudo frame generating circuit which generates skip information indicating the pseudo frame, based on the pseudo-frame generation control signal outputted from said frame managing circuit, so as to output the generated skip information;
a coding circuit which codes the frame data so as to output coded data; and
a stream generating circuit which combines, in a predetermined order, the coded data outputted from said coding circuit and the skip information generated by said pseudo frame generating circuit, so as to output the combined data as stream data

10. The image coding apparatus according to claim 2,
wherein said frame managing unit is operable to control a coding rate by calculating a target coding rate every two frames as the predetermined timing at which the frame rate is changed.

11. The image coding apparatus according to claim 3,
wherein said frame managing unit is operable to control a coding rate by calculating a target coding rate every two frames as the predetermined timing at which the frame rate is changed.

12. The image coding apparatus according to claim 4,
wherein said frame managing unit is operable to control a coding rate by calculating a target coding rate every two frames as the predetermined timing at which the frame rate is changed.

13. The image coding apparatus according to claim 5,
wherein said frame managing unit is operable to control a coding rate by calculating a target coding rate every two frames as the predetermined timing at which the frame rate is changed.
